(19) United States
(12) Patent Application Publication
(10) Pub. No.: US 2013/0254698 A1
(43) Pub. Date: Sep. 26, 2013

(54) PROJECT ACTIVITY MODEL

(71) Applicants: Kees Schelling, Heemstede (NL); Scott Snyder, Sugarland, TX (US); Anton Rouwhorst, Zandvoort (NL); Martin Bunnik, Bennebroek (NL)

(72) Inventors: Kees Schelling, Heemstede (NL); Scott Snyder, Sugarland, TX (US); Anton Rouwhorst, Zandvoort (NL); Martin Bunnik, Bennebroek (NL)

(73) Assignee: FLUOR TECHNOLOGIES CORPORATION, Aliso Viejo, CA (US)

(21) Appl. No.: 13/426,881

(22) Filed: Mar. 22, 2012

(51) Int. Cl. G06F 3/048

(52) U.S. Cl. 715/772

(57) ABSTRACT

A system and method for creating a project workflow involves tracking all activities from all disciplines within a company in a database, such that when a new workflow is created, a project architect is forced to consider every activity ever performed to the workflow in relation to every discipline. Only after activities have been assigned to their appropriate disciplines, can a user filter a view of the map to hide disciplines and activities from view. This ensures that every task ever performed by various disciplines within a company is always considered whenever designing a project workflow.

### FIELD OF THE INVENTION

The field of the invention is project management tools.

### BACKGROUND

Managers have a desire to simultaneously manage multiple resources to accomplish projects. Managers typically manage resources by creating a project management workflow that sets forth activities that must be accomplished and resources that need to be allocated to each activity. In complex environments, managers commonly use software tools, for example Microsoft Office Project™ or Oracle Project Portfolio Management™, to dynamically allocate resources and map out different workflows for optimization purposes. Users of such tools, however, frequently create a project from scratch or from a generic template that frequently has little or nothing to do with a given project.

U.S. Pat. No. 7,222,330 to Bicknell teaches a software system that dynamically generates a workflow template based upon user input. A manager wishing to design a new workflow could input static values for common variables to generate a custom template that better fits a manager's needs. However, Bicknell's template requires a manager to manually input information into the system and fails to utilize the manager's previous workflow experience to streamline the creation process. Bicknell, and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

U.S. Pat. No. 7,293,029 to Cope teaches a software system that analyzes past workflow trends to create historical records. These historical records could then be studied by competent managers to streamline the workflow generation process for future projects by refocusing a master workflow template to include highly effective activities. This process is largely manual, however, and requires a user to analyze data and manually alter a workflow template.

US2003/0083953 to Starkey teaches a software system that analyze historically successful activities within an organization to create a streamlined workflow template. Starkey's system, however, automatically parses out the least effective activities without any user input, limiting a manger's ability to judge whether or not past activities should be included in a workflow despite their lack of effectiveness in the past.

Thus, there is still a need in the art for systems and methods that generate project management workflows from past activities.

### SUMMARY OF THE INVENTION

The inventive subject matter provides apparatus, systems and methods in which past activities from at least one discipline are used to generate a visual map of a project management workflow. As used herein, a “discipline” is a specialized division of an organization with designated employees that report only to that discipline and not to other disciplines. For example, common disciplines within a company could be “human resources,” “marketing,” and “engineering.” As used herein, an “activity” is a task required to be performed by one or more disciplines during a project workflow. For example, common activities within a company could be “define requirements,” “meet with discipline management team,” and “deconstruct and summarize project.” Since an employee from “human resources” and an employee from “engineering” would be reporting to two separate discipline managers

Although the database could have a select number of past activities without departing from the scope of the current invention, all past activities that have ever been performed by a discipline are preferably collected by the database. The activities could be collected automatically as new activities are performed and detected by a computer processor connected to the database, or could be input manually into the database by specified members of a discipline, preferably an experienced administrator that ensures that the database does not get overpopulated by replica or redundant activities. Past activities from at least one, two, three, or more disciplines could be collected by the database to create an inter-disciplinary workflow map for an enterprise-wide project. In an exemplary embodiment, all disciplines in a given company or companies are monitored by a computer processor or an administrator user to ensure that the database holds all activities that have ever been performed by a company to accomplish a project.

The past activities could then be used to generate the visual map of the project management workflow by populating the map with some or all of the past activities. In an exemplary embodiment, a subset of the past activities is used to populate one or more template workflows. For example, a computer processor could analyze historical trends of successful workflows to select the most successful or necessary activities, or a manager could create a custom template manually based upon his/her own past experience or analysis. Preferably, the visual map is populated with all of the past activities from all of the disciplines in the database to ensure that a project manager weighs the merits of each and every activity before settling on a project workflow.

Once the visual map is populated with past activities, the past activities are preferably protected to prevent user deletion of a past activity from the map. This ensures that all the past activities that have been used to populate the visual map remain in the map for the lifetime of the project workflow. The method of protecting the past activity is preferably electronic, for example by write-protecting the map shortly after creation, but could be manual, for example by laminating a printout of the map.

In an exemplary embodiment, a user interface is provided that allows a user to alter a visual characteristic of a past activity. For example, the user could change or add a color, a label, a border, or some other visual indicator. In one exemplary embodiment, the user interface also preferably allows a user to add or change a visual characteristic to show one or more responsible custodians of each activity. In another exemplary embodiment, a visual characteristic could be used to show that one or more participants are responsible for a selected activity. As defined herein, a “participant” is a separate office of an organization, for example an office in a different city or a different country, or a separate organization entirely. Where two or more participants are responsible for a selected activity, a visual characteristic could be employed that shows the percentage of work each participant is responsible for.

Preferably, the user edits a legend to add or change common visual characteristics that are shared among selected groups of activities. Once selected activities are attributed to a group in a legend, the user could then edit the legend to alter the visual characteristic of all activities attributed to that group. This allows managers from different disciplines or departments to filter the visual representation of the workflow to simplify a view. In an exemplary embodiment, a user could permanently write-protect the legend to prevent deletion of a visual characteristic.

The visual map could be as small or as large as needed in order to convey all necessary information to a user. Preferably, the visual map has several views with a few common visual characteristics to simplify or otherwise focus the user's attention. For example, a separate detailed window could appear on the user interface when a user selects an activity on the visual map, allowing a user to link additional information to each activity that may not appear on the visual map. Alternatively, a user could switch between multiple views, for example a flowchart view and a table view that shows different visual characteristics that the user could show or hide based upon user preferences. In another exemplary embodiment, the visual map comprises a first view for all activities assigned to a single discipline, and a second view for all activities assigned to two, three, four or more disciplines. The user interface also preferably allows a user to delete a discipline from the map, filtering out other disciplines if necessary.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of an exemplary project management workflow system.

FIG. 2A is an exemplary project management map containing all past activities from various disciplines.

FIG. 2B is the map of FIG. 2A having each discipline and activity assigned a value.

FIG. 3 is the map of FIG. 2B, having a user interface that allows a past activity to be altered.

FIG. 4A is the map of FIG. 2B, having disciplines and activities masked.

FIG. 4B is the map of FIG. 4A, where the masked disciplines and activities have been removed from a view of the map.

FIG. 5 is an exemplary legend for modification of various visual characteristics of the map of FIG. 2B.

FIG. 6 is a view of an exemplary discipline management map.

FIG. 7 is a view of the engineering management discipline from FIG. 2B having various activities modified in accordance with the legend of FIG. 5

FIG. 8 is the view of the engineering management discipline of FIG. 7 having a user interface allowing a user to modify an activity.

### DETAILED DESCRIPTION

It should be noted that while the following description is drawn to a computer/server project management workflow, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including the ability to set forth a project plan across a plurality of disciplines by forcing a user to take into account all past activities across all disciplines before ruling out a discipline.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

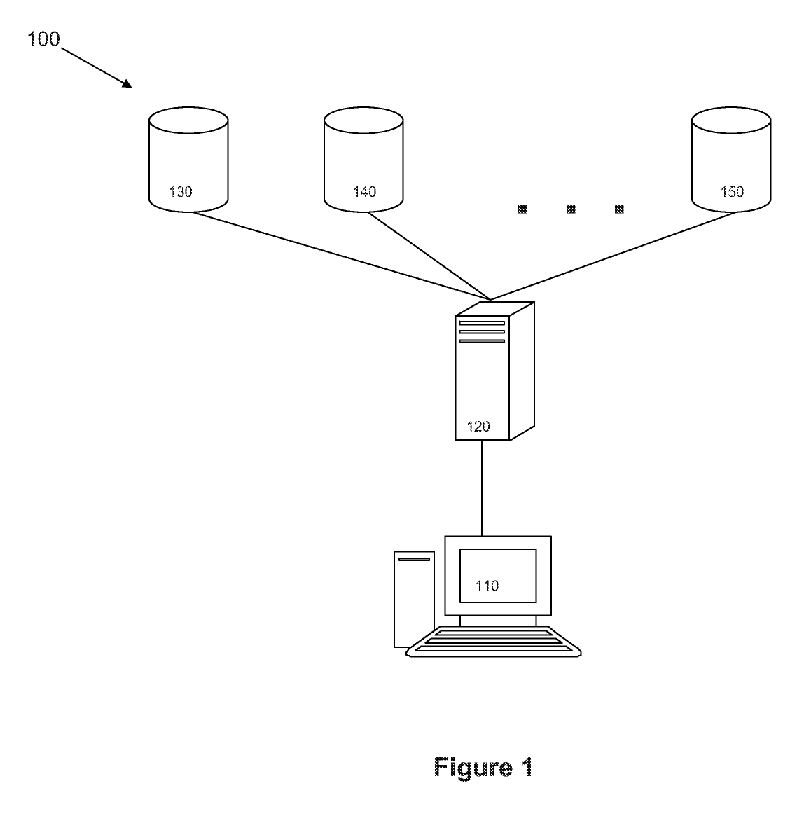

In FIG. 1, an exemplary project management workflow system 100 comprises a user interface 110 coupled to a computer system 120 that houses a plurality of databases 130, 140 and 150. A human user generally accesses the project management workflow system through user interface 110 which is exemplified herein by a computer monitor and keyboard coupled to a workstation desktop computer, although any known computer user interface could be used, for example a mouse, touchscreen, or a camera. User interface 110 is coupled to a computer system 120, typically through a wired or wireless network, which has access to one or more databases 130, 140, 150. Each database 130, 140, and 150 represents a repository of past activities for a discipline, for example an engineering database, an electrical database, and a construction management and control database. While only three databases are shown, many more databases, each representing a separate discipline, could accessed by computer system 120, such as engineering, architectural and building systems, automation, construction management and control, civil and structural, control systems, contract management, electrical, estimating, health, safety, environmental, information technology, material management, mechanical, project controls, project document management, data management, piping, pipeline, project management, process, quality assurance, and discipline management. Each database could alternatively house past activity information on more than one discipline, or alternatively a single database could hold past activity information on all past disciplines.

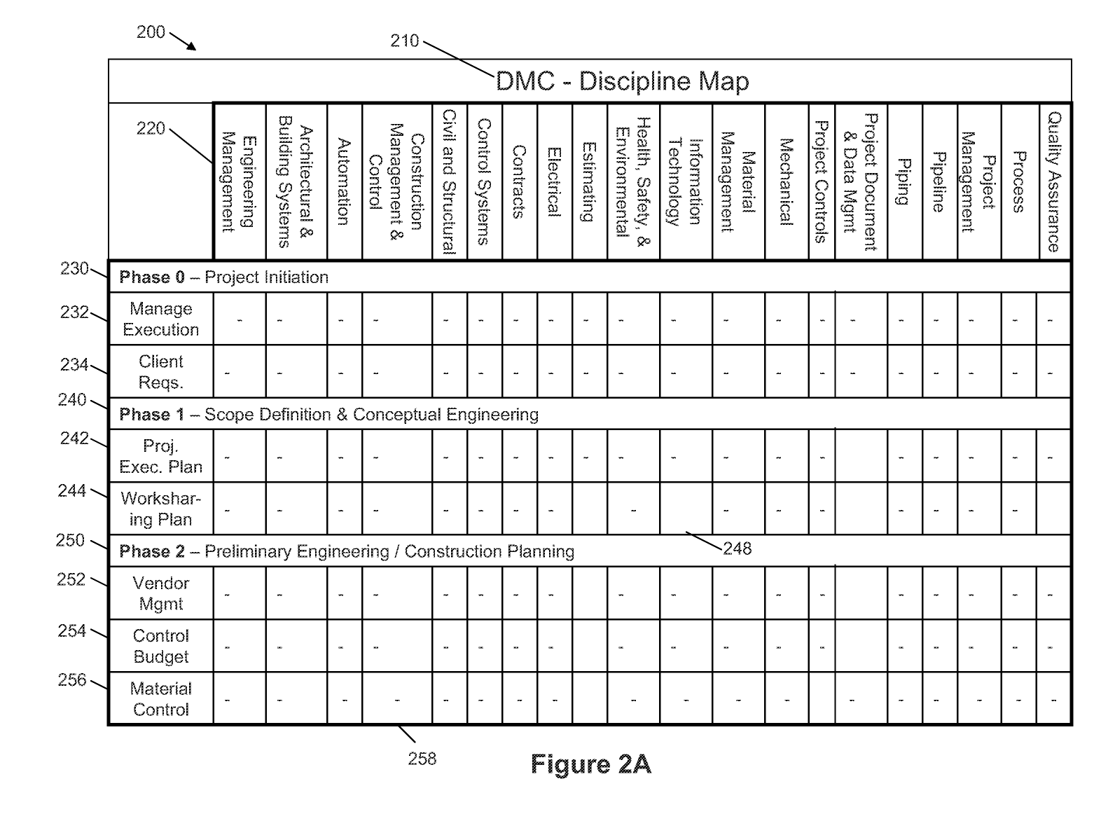

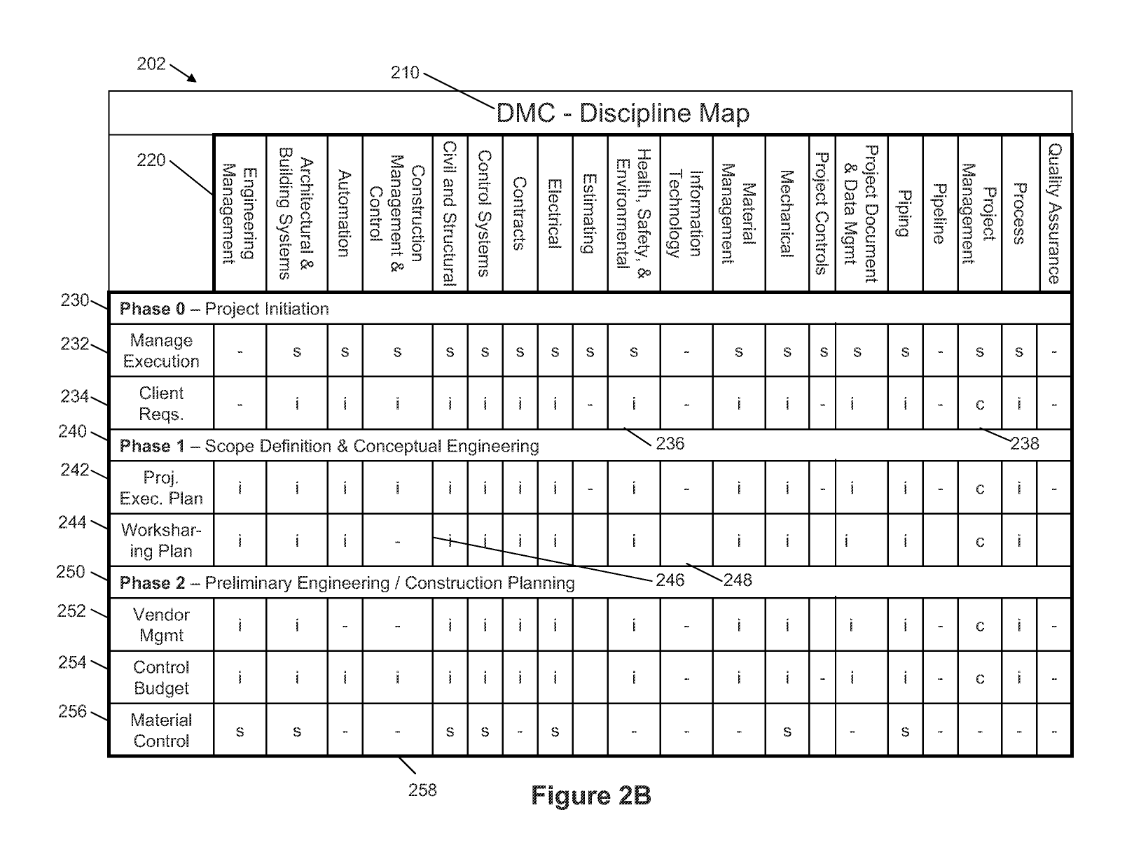

In FIG. 2A, an exemplary blank project management workflow map 200 is displayed in a user interface, having a title 210, disciplines 220, phases 230, 240, and 250, and activities 232, 234, 242, 244, 252, 254, and 256. As shown, phase 230 has two past activities—activity 232 and activity 234, phase 240 has two past activities—activity 242 and 244, and phase 250 has three past activities—activity 252, 254, and 256. At a glance, an architect of a project could see every activity that every discipline has ever performed in the history of the company. If a discipline has never been assigned to a particular discipline, the map could have an indicator about that activity, such as blank tile 246. In some embodiments, a project architect could trace through historical maps to analyze how past projects were utilized and allocated to past projects.

Once a project architect understands the extent to which past activities have been utilized by each discipline, the project architect could then analyze each activity and discipline and assign each discipline and each activity an attribute, as shown in FIG. 2B. Such an architect could mark down whether a discipline should be a custodian of the activity as shown in tile 238, an input contributor of that activity as shown in tile 236, should perform a similar activity individually as shown in tile 258, or should opt out of an activity as shown in tile 246. A single glance at an unedited map would show. FIG. 2B, an architect could mark that most of the disciplines for the activity “Manage Execution” should perform a similar activity individually; however the Information Technology discipline and the Pipeline discipline should opt out from performing that activity at all. The architect could also specify that the Project Management discipline should be the custodian of the “Client Requirements” activity, while most of the other disciplines are either assigned to provide input to the activity, or to opt out of the activity completely. A single glance at map 200 will, generally, reveal to any project manager (a) each of the activities each discipline will engage in and what role that discipline will have, (b) each of the activities each discipline has opted out of, and (c) each of the activities each discipline has never performed before in the past.

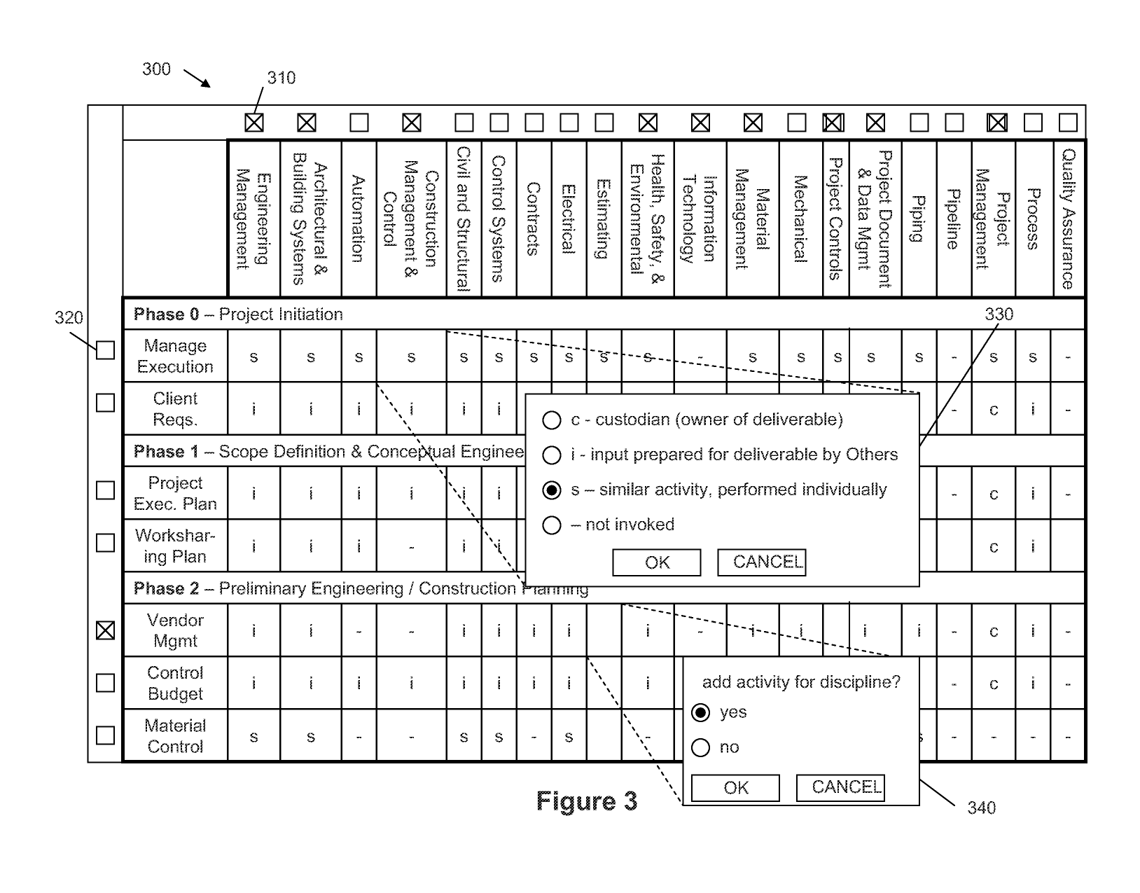

FIG. 3 shows an exemplary user interface showing how a user might edit a map and alter its features. A project architect may invoke a user interface 330 which allows the project architect to assign an attribute to each activity. A project architect may also invoke a separate user interface to add an activity to a discipline if the activity has never been performed for that particular discipline. A separate user interface, 350, could alternatively be used to add a particular activity that has never performed by any discipline ever. Once an activity has been added to a discipline, the system is preferably configured such that all future maps show that activity, and the activity then can't be removed from the map during the architecting process.

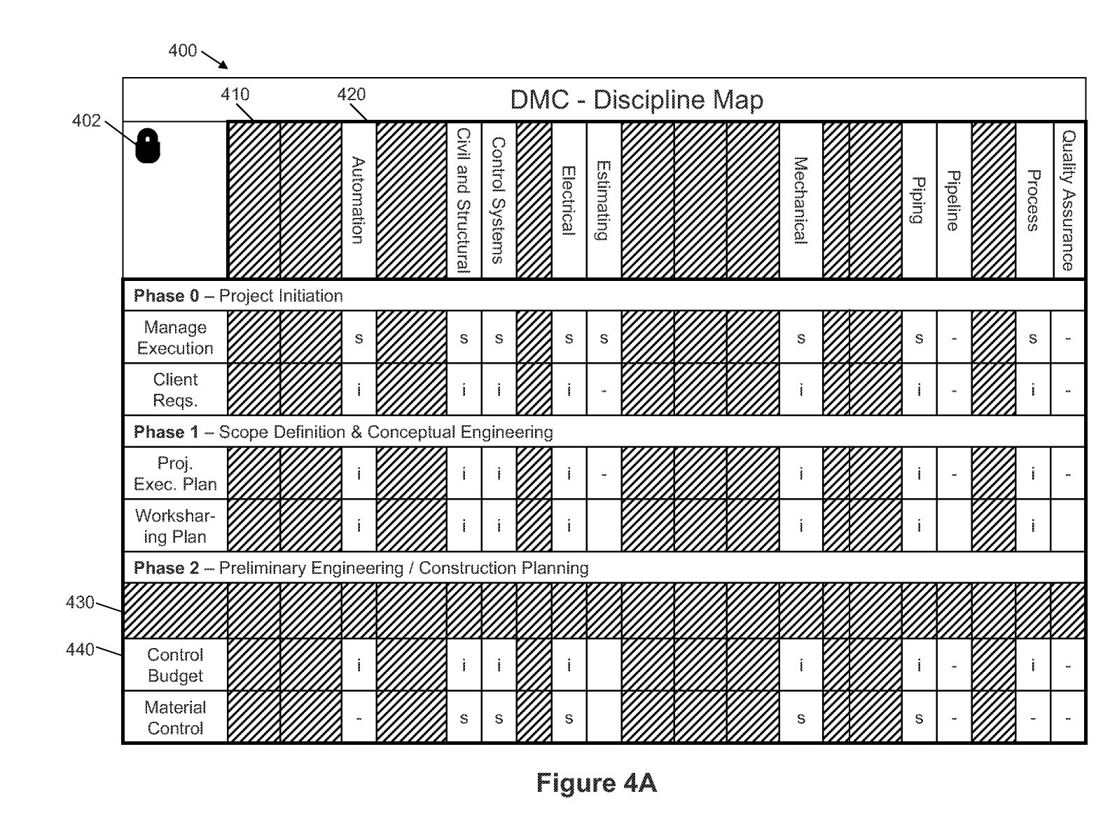

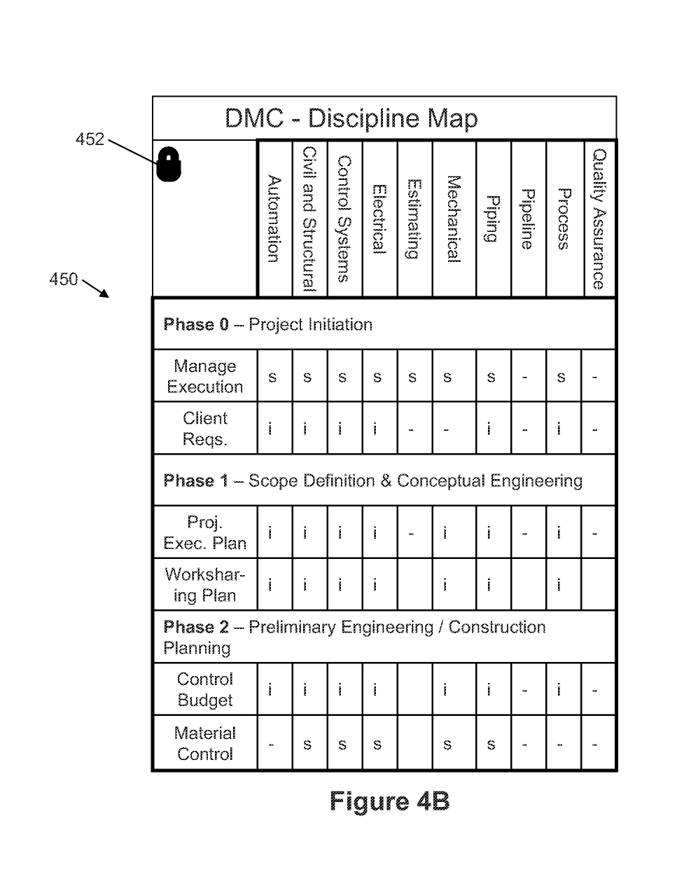

The project map may also be configured to have a user interface 310 that allows a user to hide a discipline from view, or a user interface 320 that allows a user to hide an activity from view. Preferably the project map is configured such that the user cannot hide any activities from view, so that a project architect is forced to consider whether or not a discipline should be assigned an activity before ignoring that activity. By invoking such a user interface, user may simplify a view of a map for review by showing only disciplines and activities that user is responsible for, as shown in FIGS. 4A and 4B.

In FIG. 4A, an exemplary filtered map 400 has been locked by an administrator, as shown by the lock icon 402. Hidden disciplines 410 and hidden activities 430 have been masked, while non-hidden disciplines 420 and 440 are revealed for a user to review. An alternative filtered map 450 is shown in FIG. 4B, having an optimized view that is easier to review.

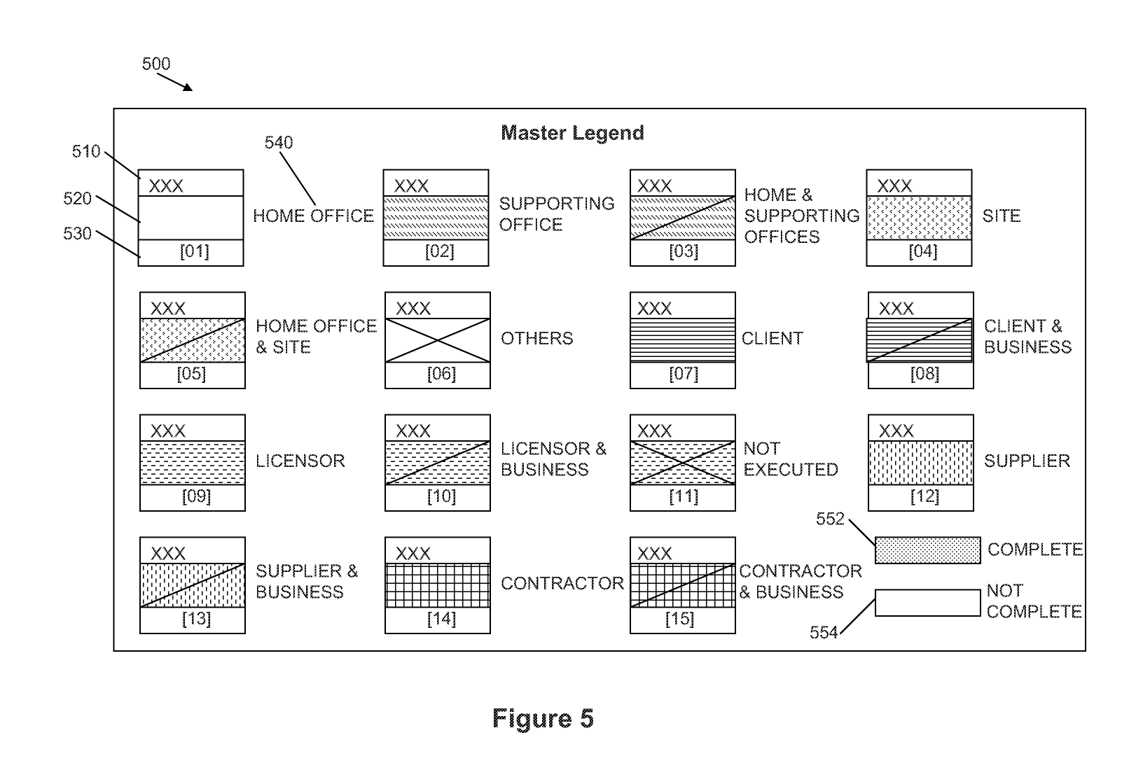

In FIG. 5, a project architect could design a master legend 500 to be used for various views of the map which could be used by a user to assign different colors and titles to be used as a project standard across all maps. Each tile of the legend could be assigned a location for an activity name 510, a visual indicator 520, a numerical value assigned to the legend tile 530, and a label for the tile 540. Here, the labels and patterns correspond to different locations that the activity is performed, although other labels could be used without departing from the scope of the invention. In a preferred embodiment, each visual indicator 520 preferably corresponds to a different color and/or pattern to the tile to help a user easily differentiate one tile from another. The legend also preferably has visual indicators 552 and 554 which show a user whether a particular activity has been completed or has yet to be completed, respectively. Once a legend is created, the legend is preferably permanently write-protected to prevent any other users from altering the visual legend, ensuring that all maps created with that legend are consistent with one another.

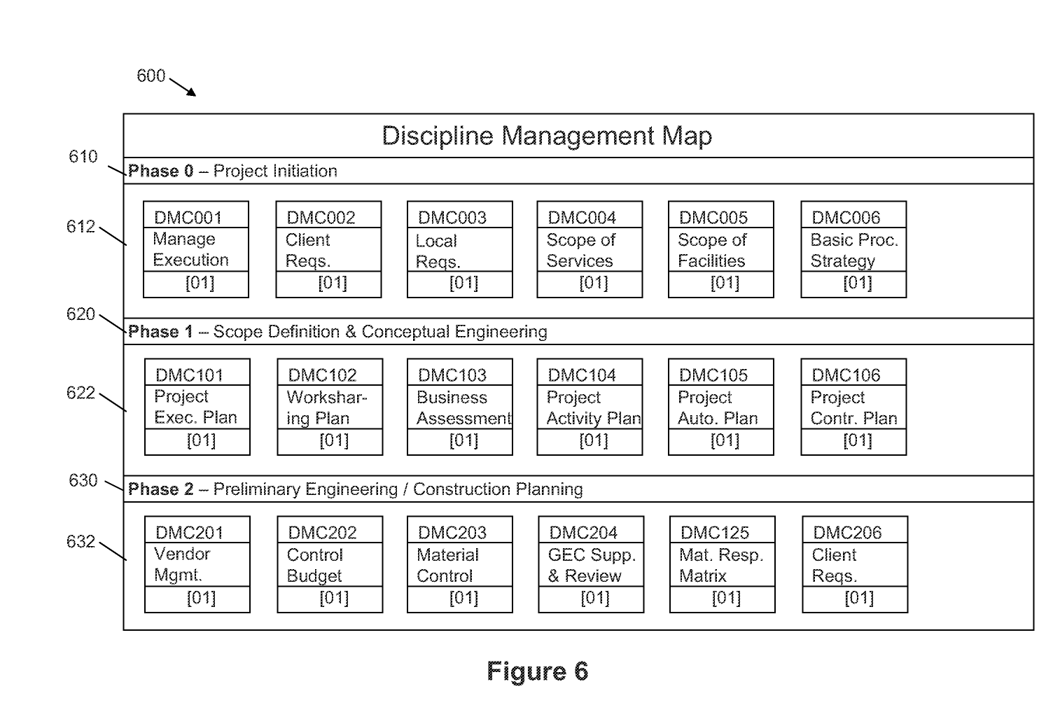

In FIG. 6, a blank discipline map 600 generally shows phases 610, 620, and 630, and different activities 612, 622, and 632 that need to be performed for each phase. Each of the tiles within the blank discipline map 600 has been arbitrarily assigned to have the attributes of tile [01] shown in FIG. 5.

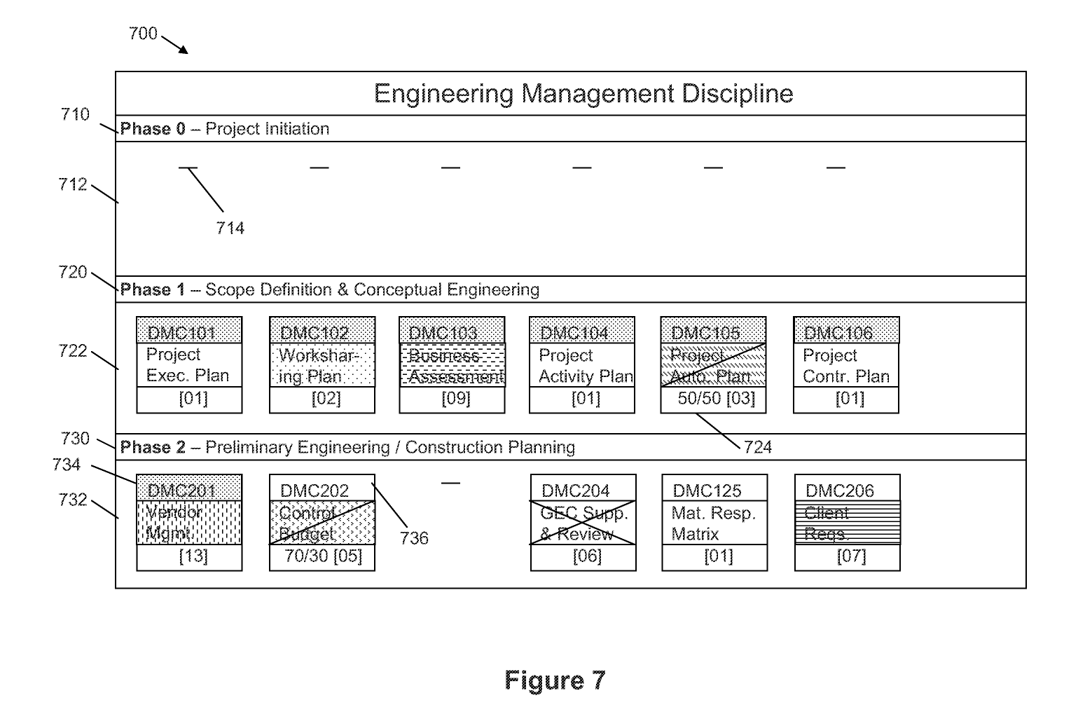

In FIG. 7, the discipline-specific map 700 for the Engineering Management Discipline is shown, which corresponds to the activities assigned to the Engineering Management Discipline in map 202 in FIG. 2B. A plurality of phases 710, 720, and 730 having various activities 712, 722, and 732, respectively, reveals all of the activities assigned to the Engineering Management Discipline. As shown, activities that the Engineering Management Discipline has opted out of are displayed as dash 714 to show a user that the activity has not been assigned to the particular discipline. Activities that the Engineering Management Discipline has assigned to it are shown via tiles that match the legend shown in FIG. 6. Some of the tiles represent activities that are split between disciplines located in separate locations, such as tile 724 which designates an activity that should be performed both at the home office and at supporting offices. Tile 724 has a label that shows that the activity should be split 50/50 between both offices. In contrast, tile 736 shows that the activity should be split 70/30 between the home office and the site. The top portion of each tile also has visual characteristics which show a user whether or not the activity has been completed. For example, the top portion of tile 734 has been shaded to show that the Vendor Management has been completed, but the top portion of tile 736 has not been shaded to show that the Control Budget has not yet been completed.

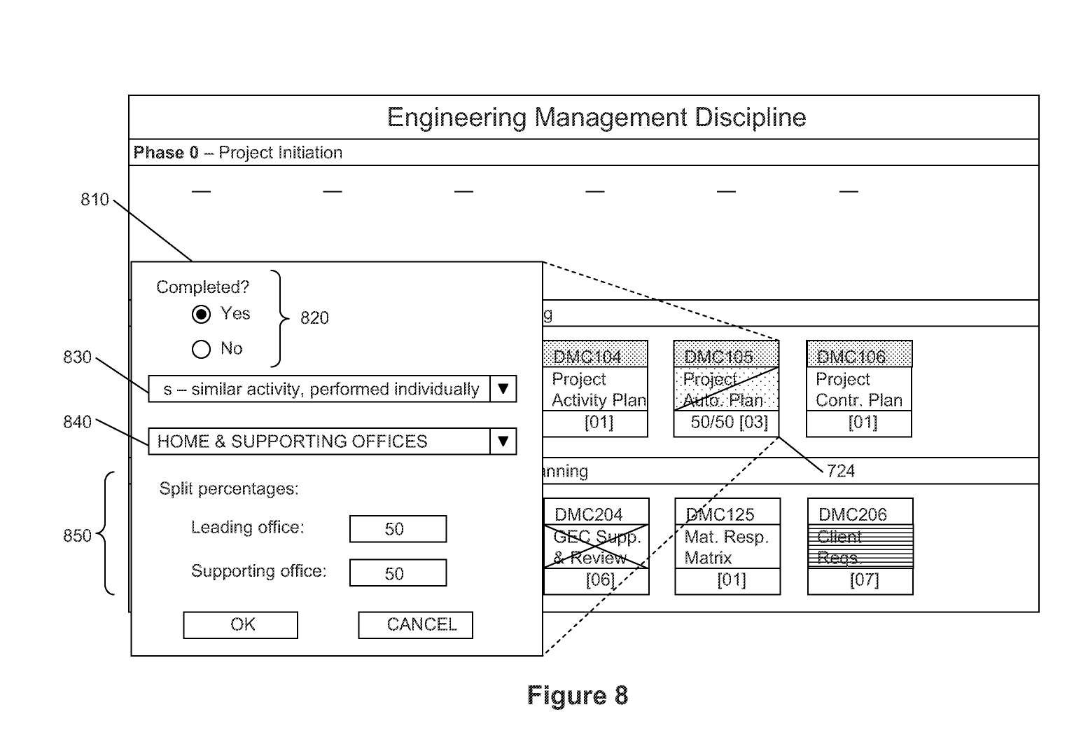

In FIG. 8, a user interface 810 is shown for tile 724 that allows a user to designate whether the activity has been completed using selection buttons 820, the role the Engineering Management Discipline has with the activity using drop-down selection box 830, the location at which the activity is performed using drop-down selection box 840, and the percentage of work that will be allocated to each office using the text boxes 850. The discipline-specific map 700 allows a manager of a single discipline to easily track process of its various activities across a plurality of offices in multiple locations in an easily understood manner.

Thus, specific compositions and methods of the inventive subject matter have been disclosed. It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of producing a visual map of a project management workflow, comprising:
collecting past activities from at least three disciplines into a database;
populating the map with a plurality of past activities from a plurality of disciplines in the database;
protecting the past activities to prevent user deletion of a past activity from the map; and
providing a user interface that allows a user to (a) alter a visual characteristic of a past activity, and (b) delete a discipline from the map.

2. The method of producing the visual map of claim 1, further comprising providing a legend of visual characteristics for the activities.

3. The method of producing a visual map of claim 2, further comprising permanently write-protecting the legend to prevent deletion of a visual characteristic.

4. The method of producing a visual map of claim 2, further comprising providing a user interface that allows a user to change a visual characteristic of the legend.

5. The method of producing a visual map of claim 2, wherein a visual characteristic of the legend represents at least two participants.

6. The method of producing a visual map of claim 5, further comprising providing a user interface that allows a user to alter a visual characteristic of a past activity to show percentage of work each participant is responsible for.

7. The method of producing a visual map of claim 1, further comprising providing a user interface that allows a user to link additional information to each activity.

8. The method of producing a visual map of claim 1, further comprising partitioning the visual map into at least two views of activities, wherein a first view of activities comprises activities assigned to a discipline, and a second view of activities comprises activities assigned to at least two disciplines.

9. The method of producing a visual map of claim 8, further comprising providing a user interface that allows a user to assign a visual characteristic to an activity that shows the responsible custodian of an activity.
